(19) United States
(12) Patent Application Publication
(10) Pub. No.: US 2006/0192122 A1
(43) Pub. Date: Aug. 31, 2006

(54) Apparatus and method for measuring fuel dilution of lubricant

(75) Inventors: Yu-Min Chen, Newton, MA (US); William Asher, Leominster, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: On-Site Analysis, Inc., Marlborough, MA (US)

(21) Appl. No.: 11/068,402

(22) Filed: Feb. 28, 2005

(51) Int. Cl. G01J 5/02

(52) U.S. Cl. 250/339.13

(57) ABSTRACT

An apparatus and methods for spectroscopic analysis of a petroleum product, including detecting and quantifying fuel dilution in an oil sample are disclose. The apparatus includes a sample reservoir for receiving a liquid sample of a petroleum product, a heater for heating a sample in the sample reservoir, a vapor collector for collecting vapors released by heating the liquid sample, and a spectrometer for analyzing the released vapors.

### FIELD OF THE INVENTION

The present invention relates to apparatus and methods for evaluating the contamination of lubricants, and in particular to detecting and/or quantifying the concentration of fuel present in hydrocarbon based lubricating oils.

### BACKGROUND OF THE INVENTION

The concentration of fuel in crankcase lubrication oil provides an important indication of engine condition and can signal the need for engine maintenance. Most engines collect some fuel in the crankcase oil under normal operation, however excessive fuel dilution usually indicates engine malfunction, improper operation, or overly extended periods between oil changes. The most common ways for fuel to enter the crankcase include direct leakage of fuel from the fuel system and blowby of fuel-containing combustion gasses. Sources of direct leakage include fuel/oil heat exchangers, dribbling injectors, and worn out piston rings. Conversely, blowby occurs as a result of incomplete or ineffective combustion caused by an improper air/fuel ratio, excessive piston ring clearance, poor injection, incorrect spark timing, excessive engine idling, and/or other engine malfunctions.

Fuel dilution directly reduces oil viscosity and the concentration of anti-wear additives resulting in the loss of engine lubrication. The lack of proper lubrication initiates or accelerates engine mechanical wear and can cause severe damage to oil-wetted parts such as bearings, gears, pistons, etc. Fuel dilution can also promote or increase corrosion, loss of oil dispersancy, and the potential for fire or explosion. Therefore, detection of fuel dilution not only helps to diagnose existing problem, but also serves as a warning of future engine damage.

Currently, several techniques and methods are available for routine detection and quantification of fuel dilution in crankcase lubrication oil. These include gas chromatography analysis, liquid-phase infrared absorbance spectroscopy analysis, oil flash point and/or viscosity tests, and analysis with Surface Acoustic Wave (SAW) based “fuel sniffer” machines.

Gas chromatography analysis is based on a separation technique which allows a user to separate fuel from an oil sample, if present, and to determine fuel concentration. This technique has been approved as standard methods: ASTM D3254 for diesel fuel dilution and ASTM D3525 for gasoline fuel dilution. Although gas chromatography gives good information about fuel dilution, the measurement is not quick or easy to make, and requires high-level technicians. In addition the instrument and associated sampling materials are expensive.

Liquid-phase IR absorbance spectroscopy measures fuel dilution by examining aromatic absorbance bands in the sample spectrum. Fuels contain more aromatics than oils so an increase in the aromatic absorbance bands, relative to new oil of the same brand and grade, provides an indication of the presence of fuel in an oil sample. Liquid-phase IR absorbance spectroscopy is lower cost per sample analysis and easier to perform than gas chromatography, however, the results are uncertain and prone to false negative or positive results. In particular, the problem with liquid-phase IR spectroscopy is that the spectral base line obtained with new reference oil provides a poor match to that of the used oil sample.

Flash point tests detect the fuel dilution based on a reduction in oil flash point caused by fuel contamination and are quite sensitive to the fuel dilution. For example, a 3% diesel fuel dilution causes a flash point reduction of 50° C. However, the reduction in flash point varies significantly among oils of different brand or grade, and such a drop does not have a linear relationship with fuel concentration. Therefore, the calibration becomes oil brand or grade specific and requires more standard samples with different fuel concentrations. In addition, a finite flash point measurement takes a long time and requires more samples.

Viscosity decrease may indicate the presence of fuel in the oil. However, other factors such as oxidation and water contamination also cause viscosity depression. In practice, this method is only applied to approximate the fuel level in the oil and substantial fuel dilution can occur before noticeable depression of oil viscosity.

SAW sensors, such as the Fuel Sniffer, developed jointly by U.S. Navy and Microsensor Systems Inc., and now commercialized by Spectro, Inc., measure the fuel vapor concentration in a sample headspace and correlates it to the fuel concentration in the oil. Although the SAW sensor takes only about one minute to measure one sample, it requires that the samples not be analyzed immediately after they are taken, but that they remain at room temperature for at least 10 to 15 minutes to reach equilibrium between the headspace vapor and the liquid sample. This may limit the application of this device for on-site analysis since the temperature at the site is largely environmentally dependent. In addition, disturbances in or contamination of the headspace vapor can affect the measurement accuracy.

A common factor that complicates and challenges all of the currently available techniques for fuel dilution is the standard sample used for calibration. Both fuel and oil are complex mixtures of many compounds. Ideally, the fuel and the reference oil used to make the standard sample should have the same compositions as the fuel and oil in the real sample to be analyzed. This seems to be impossible in the real world for two reasons. One is that the composition of a fresh fuel or oil depends largely on the source of crude oil, refinery processes, and the additives added to the oil. It is not unusual that the composition of the same grade of fuel can very widely from one station to another or from time to time. The second reason that the composition of the fresh fuel or oil can be quite different from the standard is that chemical changes occur in oil and fuel during use. For example, the fuel found in a crankcase can have a significantly higher percentage of heavy end or less volatile compounds. The extent of the variation depends on the mechanism of the fuel entering the crankcase and the evaporation rate of fuel in the crankcase. Therefore, using fresh fuel for standard sample may deflate the measured fuel level in the used oil sample. Similarly, oil composition can change significantly in the engine crankcase due to oil degradation, additive depletion, and the build-up of combustion or engine-wear by-products etc. As a result, using fresh oil as a reference or for standard sample preparation may lead to poor measurement accuracy, and sometimes false positive or negative results.

Accordingly, it is desired to have a device for on-site measurement of fuel dilution. Such a device should be compact, cost effective, easy to operate, and provide reliable results.

### SUMMARY OF THE INVENTION

The present invention provides apparatus and methods for testing a sample for the presence of a contaminant. In one embodiment of the invention, the apparatus includes a sample reservoir for receiving a liquid sample of a petroleum product, a heater for heating the sample in the sample reservoir, a vapor collector for collecting vapors released by heating the liquid sample, and a spectrometer for analyzing the released vapors.

In one aspect, the sample reservoir and vapor collector form a sealable chamber such that vapors released by heating of the petroleum product are captured in the vapor collector for spectroscopic analysis. Preferably, the device also includes a temperature sensor for monitoring the temperature of the oil sample. A fill sensor for monitoring the level of the oil sample in the sample reservoir can also be included. A controller responsive to a sensor may further be included for controlling sample temperature and/or fill levels.

In another aspect of the invention, the apparatus includes a light source and at least one infrared detector positioned to analyze vapor in the vapor collection area. In a further aspect, multiple infrared detectors are used and the distance between the light source and a first detector is longer than the distance between the light source and a second detector. Preferably, the first and second detectors detect different fuel components. For example, the detector closer to the light source could detect gasoline fuel vapors and the more distant detector could detect diesel fuel. Gasoline is more volatile and has higher vapor pressure than diesel. So, a gasoline contaminated oil sample shows stronger infrared absorbance in the vapor phase than does a sample with the same level of diesel contamination. Therefore, a shorter vapor cell path length can be used to measure the gasoline. Shorter cell path can avoid the opacity of vapor in the longer diesel leg of the cell. The device can also include additional detectors for detecting other contaminates or for use as a reference detector.

In yet another aspect, the present invention is adapted for use with a disposable sample reservoir. For example, the device can include a receptacle for receiving a disposable sample reservoir, a heater for heating a disposable sample reservoir, a vapor collector adapted for coupling with a disposable sample reservoir to collect vapors released by heating a liquid sample, and an infrared spectrometer for analyzing vapors in the vapor collector. The device may additionally include disposable sample reservoirs.

In another embodiment of the present invention, a method for spectroscopic analysis of motor oil is provided. The method includes delivering a motor oil sample containing a volatile contaminant to a sampling reservoir, heating the sample to increase the vapor-phase concentration of the volatile contaminant, and spectroscopically analyzing the vapor-phase. In one aspect of the invention the petroleum sample is heated to a temperature sufficient to at least partially vaporize diesel fuel contaminants present in a motor oil sample. In another aspect, the petroleum sample is heated to a temperature sufficient to at least partially vaporize gasoline fuel contaminants.

### BRIEF DESCRIPTION OF THE DRAWINGS

The invention can be more fully understood from the following detailed description taken in conjunction with the accompanying drawings, in which:

FIG. 1 is a schematic side view of one embodiment of the spectroscopic motor oil analyzer of the present invention;

FIG. 2 is a top view of the analyzer of FIG. 1;

FIG. 3 is a schematic view of the band pass filter-based, vapor-phase IR Spectrometer that can be used with one embodiment of the analyzer disclosed herein;

FIG. 4A is a perspective view of another embodiment of the analyzer disclosed herein;

FIG. 4B illustrates the analyzer of FIG. 4A with the sample chamber door open;

FIG. 4C is a side view of the analyzer of FIG. 4A;

FIG. 4D is a cut-away side view of the analyzer of FIG. 4A;

FIG. 5 is vapor-phase absorbance spectra of (a) 1% gasoline fuel in motor oil and (b) motor oil (offset by −0.02);

FIG. 6 is vapor-phase absorbance spectra of (c) 5% diesel fuel in motor oil, (d) motor oil (offset by −0.004), and (e) a used motor oil with no fuel (offset by −0.008); and

FIG. 7 is vapor-phase absorbance spectra of a diesel fuel diluted motor oil superimposed with transmission spectra (with an arbitrary scale) for two different band-pass filters.

### DETAILED DESCRIPTION OF THE INVENTION

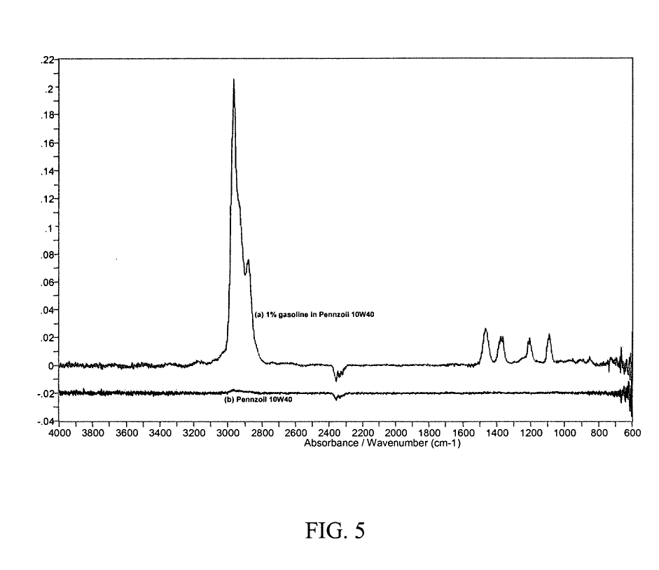

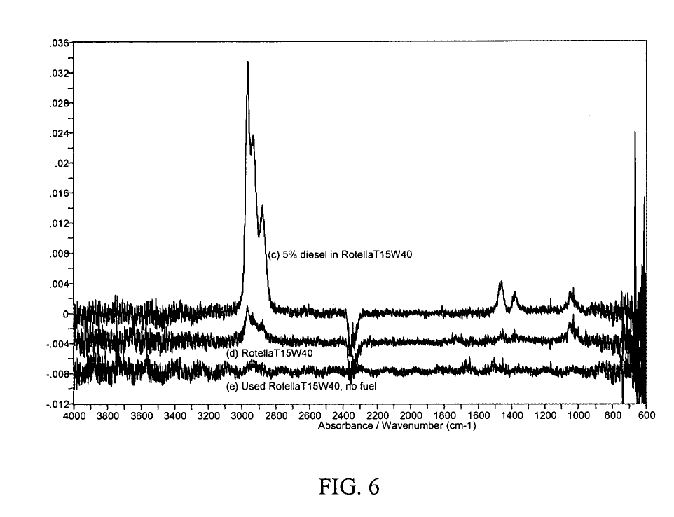

Gasoline and diesel fuels have a lower boiling range than base oil, although there is some overlap in the boiling range between the heavy end of diesel fuel and the light end of base oil. This difference in boiling ranges means that fuel has a higher vapor pressure than oil at a given temperature below the boiling range of oil. This further means that within a selected temperature range, the fuel in the contaminated oil sample can be partially evaporated to the vapor-phase and therefore separated from the oil. FIGS. 5 and 6 show that oil by itself essentially makes no contribution to the IR absorbance in the vapor-phase within such a temperature range.

The present invention provides methods and apparatus for spectroscopic analysis of a petroleum product to test for fuel contamination by measuring the IR absorbance in the vapor-phase sample. One embodiment of the invention includes a sample reservoir for receiving a liquid sample of a petroleum product, a heater for heating the sample in the sample reservoir, a vapor collector for collecting vapors released by heating the liquid sample, and a spectrometer positioned for analyzing the released vapors within the vapor collector.

By heating the sample and spectroscopically investigating the associated vapor-phase, the present invention provides a highly reliable and consistent detection of fuel contamination in motor oil. Moreover, in a mixture of liquids, the partial vapor pressure for each component can be related to its concentration in the liquid mixture. Therefore disclosed method and device can also quantify the fuel contamination by measuring the IR absorbance intensity in vapor-phase and correlating it with the fuel concentration in the oil.

The device of the present invention can spectroscopically measure the vapor-phase to determine if fuel contamination is present in a motor oil sample. The resulting information is useful for diagnosing motor problems and indicating the level of engine maintenance.

Preferably, the sample being analyzed is heated prior to spectroscopically testing the vapor-phase. Raising the sample temperature to a range that is significantly above room temperature, for example 55-120° C., increases the concentration of the contaminant in the vapor-phase. Spectroscopic testing of the vapor-phase for the presence of the contaminant is thereby improved. In one embodiment, the sample is used motor oil and the contaminant is a fuel. By heating the sample, the vapor-phase contribution of the fuel is increased. Since engine damage from fuel contamination begins with as little as 1.0 volume percent of fuel in the lubricating oil, the vapor-phase component of a heated oil sample provides a better target for analyzing fuel dilution.

Heating the sample also provides several other benefits unappreciated by the prior art. In particular, heating the sample provides a relatively quick sampling regimen because the volatile fuel contaminants are forced into the vapor-phase at a faster rate. The sampling procedure is thus relatively speedy. Heating the sample also allows the user to overcome problems created by variations in the ambient temperature. Since vapor-phase concentration of sample components varies with temperature, components would vary with the local temperature. Thus, attempting to test a sample at ambient condition could lead to errors based on varying room and equipment temperatures. The present invention heats the sample to a known temperature and provides a more consistent testing regimen.

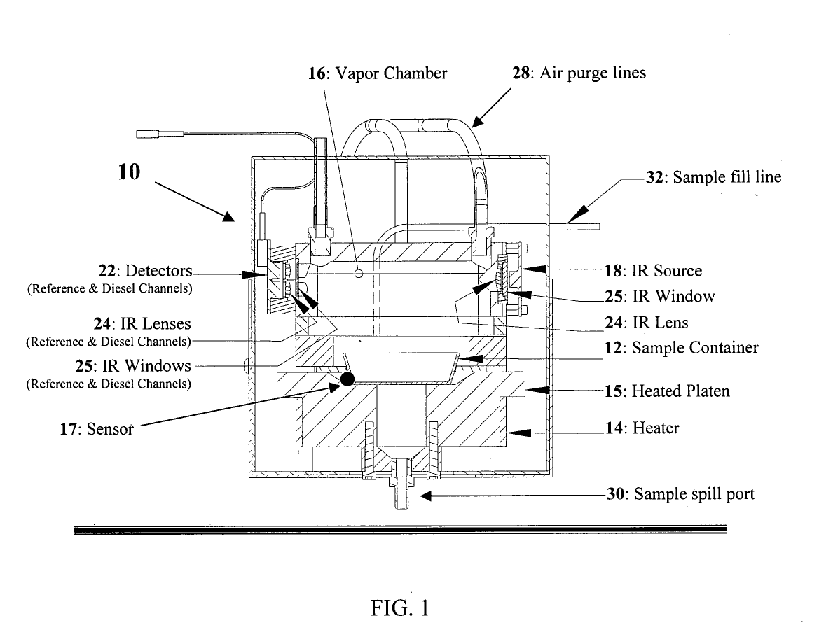

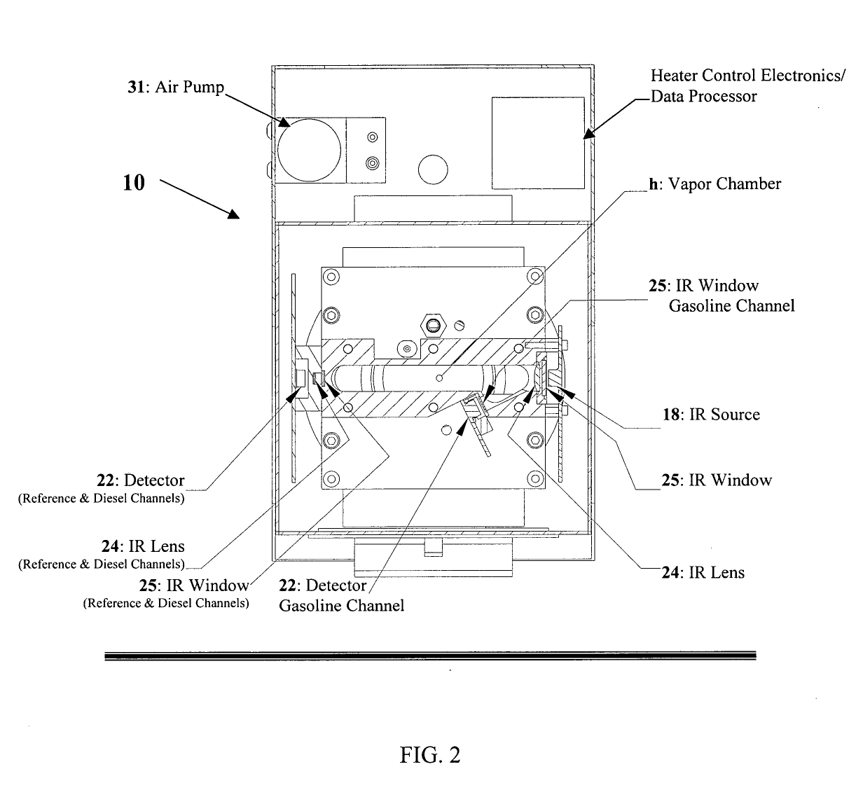

One embodiment of the present invention is illustrated in FIGS. 1 and 2. As shown, device 10 includes a sample reservoir 12 for receiving a sample. Preferably the sample is a used lubricating oil, such as motor oil from a gasoline or diesel engine. The device also includes a heater 14 for raising the temperature of a sample to a desired set point or range. One skilled in the art will appreciate that there are a variety of ways to heat the sample including electric heaters, infrared heaters, combustion based heaters, etc., all of which can heat the sample directly or indirectly. For example, heater 14 can be an electric conductive heater that heats the sample reservoir and thereby indirectly heats the sample. The device may also include a preheater to speed the analysis and to reduce sample viscosity. Alternatively, heater 14 can be a radiant heater that heats the sample by radiant energy. In other embodiments, the heater can provide a combination of both conductive and radiant heat.

Device 10 additionally includes a vapor chamber or vapor collector 16 for collecting vapors released from the liquid sample. The vapor collector as shown in FIG. 1 can be an enclosed area above the sample reservoir that is preferably sealed off from outside air during heating and testing of the sample. Preferably, vapor collector 16 has sufficient volume to collect vapor-phase sample for analysis, yet is not so large that the collected sample is unnecessarily diluted by air contained within the sample reservoir.

Monitoring sensors can also be included in measuring device 10. A temperature sensor, such as a thermocouple 17, can be positioned in contact with the sample reservoir and/or the sample for monitoring sample temperature. The temperature sensor can be used in conjunction with a controller to control the heater and to achieve the desired sample temperature. A fill sensor, such an ultrasonic sensor, can also be used to with device 10 to signal when the sample reservoir is full.

FIGS. 1 and 2 include exemplary spectroscopic components used for spectroscopically testing vapor within vapor collector 16. A person skilled in the art will appreciate that a variety of spectroscopic apparatus and techniques are available for testing vapor-phase samples. In the illustrated embodiment an infrared (“IR”) based detection is used. The IR detection components include an IR source 18 and detector 22. The IR apparatus may additionally include lens 24 for focusing the IR radiation and/or window 25 to protect the IR instruments.

The spectroscopic elements can, in one embodiment, be arranged specifically for detecting diesel and/or gasoline fuel in a sample. For example, the detectors used to detect IR radiation in the apparatus can be spaced at particular lengths from the light source depending on which contaminants the device is attempting to detect.

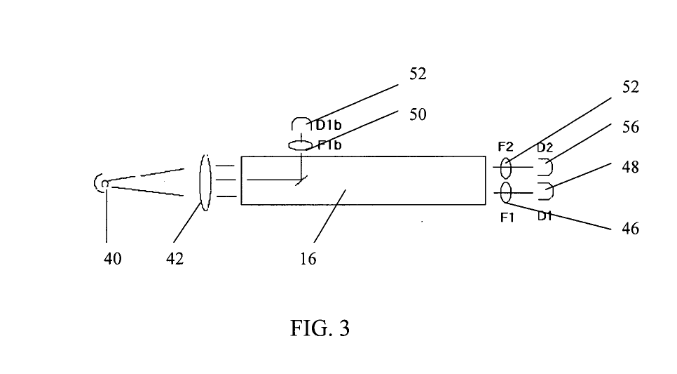

FIG. 3 schematically illustrates the IR detection components that can be used in device 10. As shown, an IR beam from a light source 40 is focused by lens 42 and passes through vapor sample collector 16. A bandpass filter 46 (F1) allows certain wavelengths of the light to pass though it and to be detected by detector 48. The apparatus can also include filter 50 and detector 52 positioned more closely to light source 40. Preferably, the more distant detector (48) is used to test for diesel fuel dilution, while the closer detector (52) is used to detect for gasoline fuel dilution. In one embodiment, the effective length of the vapor sample collector is about 10 cm for diesel fuel dilution and about 3 cm for gasoline fuel dilution. The apparatus may additionally include a third filter 54 and detector 56 for use as a reference detector. The reference filter 54 has its pass band located in a spectral position where hydrocarbon vapors do not absorb infrared energy. As such, the output of the reference detector is unaffected by the presence or absence of hydrocarbon vapor in the cell. This permits the reference detector to monitor the output of the IR source and the condition of the optics and windows of the vapor cell. The reference detector is further used to determine when the cell has been adequately purged of vapor to begin measuring a new sample. This is accomplished by comparing the output of the gasoline and diesel detectors when the cell is clean to the output of the reference detector. Clean-cell ratios of their output voltages are established that indicate the cell is purged and ready for reuse.

After performing spectroscopic analysis on a sample within the vapor sample collector, any gas phase and/or liquid phase sample in the measuring apparatus is preferably removed. For example, an air pump can purge the vapor collection chamber after use, via an air purge line 28 (FIG. 1), so as to avoid any vapor-phase cross contamination between samples. In addition, a drain valve 30 (FIG. 1) and/or pump can remove any liquid phase sample after testing. Other means to remove unwanted sample and prevent cross contamination may also be included in the measuring apparatus. For example, the sample reservoir can be coated with a nonstick surface. In addition, an optional washing step can be performed between sample testing procedures to assure removal of any old sample.

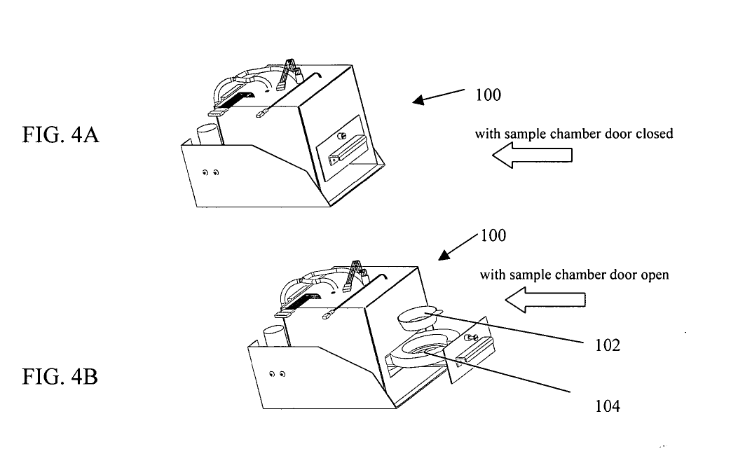

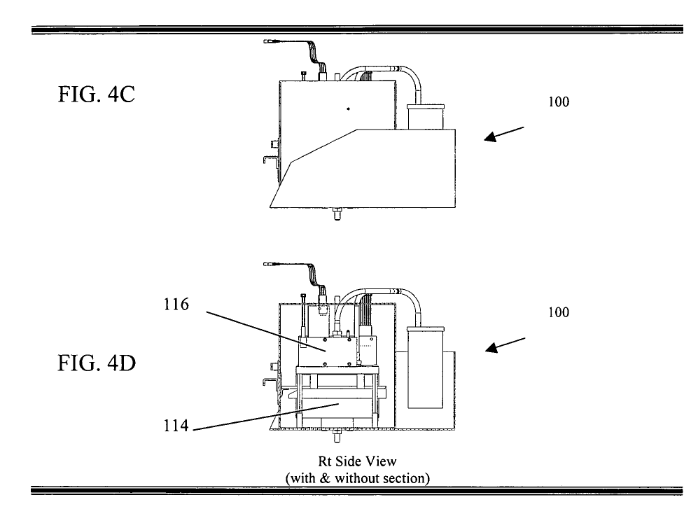

In another embodiment of the present invention, the device receives a disposable sample reservoir. Instead of having to flush the sample container after each use, a new disposable sample reservoir can be inserted into the device for each sample. In one aspect, device 100 includes receptacle 102 for receiving a disposable sample reservoir 104 as shown in FIGS. 4A through 4D. The sample can be deposited in disposable reservoir 104 and held in the reservoir during testing. After the testing is finished, the disposable reservoir can be disposed. Heater 114 (FIG. 4D) can directly or indirectly heat the disposable sample reservoir and/or the sample. Preferably, disposable sampling reservoir 104 is positioned in conjunction with the device such that vapors given off by a sample within the disposable sampling reservoir can be tested in vapor collector 116 by the spectrometer.

Device 100 can be adapted in a variety of ways for holding or mating with the disposable sampling reservoir. In one embodiment, receptacle 102 holds disposable sampling reservoir 104 in a nesting arrangement. Receptacle 102 can slide out of device 10 and have a shape corresponding to at least a portion of the outer surface of disposable sample reservoir 104. After receiving the disposable sampling reservoir, the receptacle can be slid into device 10 and sealed inside to trap sample vapor. A person skilled it the art will appreciate that the receptacle can have a variety of other forms.

The present invention also includes a variety of methods for spectroscopic analysis of motor oil. In one aspect, prior to sampling, the device is calibrated against an empty vapor chamber. For example, to assure the removal of contaminates, the heater can preheat the sample reservoir and the vapor collector can be purged with fresh air. IR readings can then be taken by recording the voltages of the detectors and the data can be used to calibrate the IR system.

To begin testing, a sample is introduced into the device. An oil sample suspected of containing a volatile contaminant, such as fuel-containing motor oil, is preferably delivered to the sampling reservoir. In one embodiment, the oil sample is delivered through a sample fill line 32 (FIG. 1). In another embodiment, the sample is deposited in a disposable sampling reservoir and the method includes the step of placing the disposable sampling reservoir in position for sampling. Once the sample is deposited within the device, the elevated temperature causes the vapor-phase concentration of the volatile contaminant to increase within the vapor sample collector. With the sample heated to the desired temperature, the vapor-phase is spectroscopically analyzed.

The temperature selected for heating the motor oil is preferably sufficient to at least partially vaporize a volatile contaminant. In one embodiment the temperature is sufficient to vaporize diesel and/or gasoline. In a further embodiment, the sample is heated to a temperature in the range of about 55° C. to 120° C.

After heating and vaporizing at least a portion of the sample, the vapor-phase is spectroscopically tested. A processor and/or a user can then analyze the resulting data to determine if contaminants are present. In one embodiment, the spectroscopic analysis focuses on the 2800 to 3200 cm⁻¹ range where fuel contaminates, such as diesel and gasoline, can be detected.

In addition to detecting the presence of contaminants, the data can be used to approximately determine the concentration of contaminants. As detailed in below, for example, a correlation between the IR absorbance data with a table of known concentration levels of standard samples can provide concentration information for the unknown samples.

The following examples are illustrative of the principles and practice of this invention. Numerous additional embodiments within the scope and spirit of the invention will become apparent to those skilled in the art.

In the follow examples the C—H stretching bands are collectively measured with an IR detector. The intensity of IR signal can then be correlated to the concentration of the fuel present in the lubricant oil.

### EXAMPLE 1

In Example 1 two samples are prepared and tested. Sample (a) contains 1% gasoline fuel in PENNZOIL®, and sample (b) contains just PENNZOIL®. An absorbance spectrum of the vapor-phase of each sample was taken as shown in FIG. 5. The spectrum of Sample (b) shows minimal absorbance. Clearly the motor oil did not make a significant contribution to the vapor-phase. Conversely, the spectrum for sample (a) shows strong absorbance peaks between 2800 and 3000 cm⁻¹. Based on the comparison between the spectra of samples (a) and (b), the contamination of sample (a) is clearly indicated. If fuel concentration data is desired, the intensity of the peaks between 2800 and 3000 cm⁻¹ can be used for correlation. For example, the peaks can be correlated with the average of the intensities of a matrix of oil samples with known concentrations of fuel contamination.

### EXAMPLE 2

In Example 2, a similar example was performed for diesel fuel dilution. Samples (c), (d), and (e) were examined with vapor-phase FT-IR absorbance spectroscopy. Sample (c) contained 5% diesel fuel in Shell RotellaT®, a typical mineral-based, motor oil, sample (d) is RotellaT® (offset by −0.004), and sample (e) is a used RotellaT® sample with no fuel (offset by −0.008). As shown in FIG. 6, the sample contaminated with diesel fuel clearly exhibited strong absorbance peaks in its spectrum in the 2800 to 3000 cm⁻¹ range. Note that sample (d) containing new motor oil showed very small peaks in the same range, however, the differences in spectra between sample (c) and (d) were dramatic. Again, the presence of fuel dilution is easily recognized.

As shown, the measurable IR absorbance bands are the bands between 2800-3000 cm⁻¹. These bands are mainly from the CH antisymmetric and symmetric stretching of CH3 and CH2 groups in aliphatic compounds and collectively represent the majority of components in the fuel.

### EXAMPLE 3

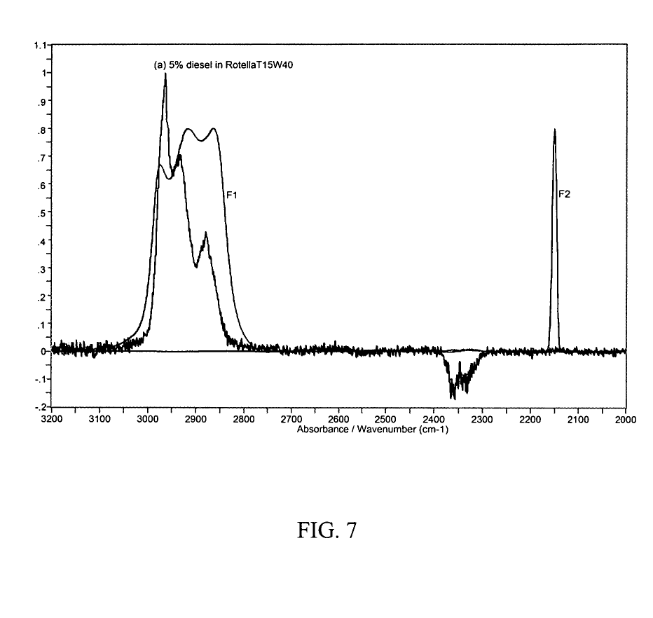

In Example 3, an IR detector apparatus similar to that illustrated in FIG. 3 was used to examine the spectroscopic detection procedures. To eliminate background thermal noise and to excite the rate-sensitive pyroelectric detectors, the IR light source is mechanically (via a chopper) or electrically pulsed at a stable frequency in the range of 3-100 Hz. This modulation permits synchronous demodulation of the signal output from the detectors to improve the signal-to-noise ratio. Filter 46 (F1) is selected to measure the C—H stretching bands, and filter 52 (F2) is used as a reference filter and is placed around 2300 cm⁻¹ region where no vapor-phase sample absorbance bands appear (as shown in FIGS. 5 and 6). The reference filter monitors the fluctuation of the light source and background drift. FIG. 7 shows the spectra of F1 and F2 superimposed with the vapor-phase spectrum of a diesel dilution sample with the presence of diesel clearly shown.

In a further embodiment of the method and device described here, a part of the sampling procedure can include calibrating the device. In one embodiment, calibration includes running the device with a matrix of oil samples doped with known amounts of gasoline or diesel fuel. The strength of the absorbance bands in the 2800-3000 cm⁻¹ region from the fuel vapor can be correlated with the actual concentration of fuel that was doped into the oil samples. To remove possible error introduced by the presence of small amounts of volatile compounds sometimes present in unused motor oils, the oils to be used for preparing calibration samples can be heated prior to calibration to out-gas and remove the volatiles from the oils before doping with fuel. For example, the fresh oils to be used for preparing calibration samples can be out-gassed for 20 minutes at a temperature of 80° C. before adding known concentrations of fuel.

In another embodiment of the measurement process, calibration is incorporated into the measuring procedure used to measure each sample. In this procedure, one pure component of fuel (instead of a real fuel) is selected to make standard calibration samples. For example, a C8 paraffin can be used to calibrate the device where the used motor oil being tested is from a gasoline engine and a C14 paraffin can be used for samples from a diesel engine. These paraffins are reagents readily obtained from chemical supply firms and are thus reproducible. In the measurement procedure, the unknown used motor oil sample is divided into two portions. One portion is weighed first and then a known amount of C8 or C14 paraffin is added. The IR absorbance of the two samples is then measured one after the other. The fuel concentration in the unknown sample can then be calculated by extrapolating the absorbance to zero, and reporting as C8 or C14 equivalent, such as C8% for gasoline and C14% for diesel. Because the standard sample has exactly the same spectral background as the unknown sample, this method resolves the potential issues of interlaboratory discrepancy, where the same sample may give different results from different labs even with same kind of instrument. This is often due to variations in the fuel and fresh oil used to make the standard samples. In addition, the IR absorbance of C8 or C14 standard sample can be correlated with a real, fuel-contaminated, standard sample, and therefore the measured C8% or C14% can be easily converted to an approximate real fuel concentration in weight %.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

1. An apparatus for spectroscopic analysis of a petroleum product, comprising:
a sample reservoir for receiving a liquid sample of the petroleum product;
a heater for heating a sample in the sample reservoir;
a vapor collector for collecting vapors released by heating the liquid sample; and
a spectrometer for analyzing the released vapors.

2. The apparatus of claim 1, wherein the spectrometer further comprises a photodetector to detect a spectroscopic signature of at least one volatile hydrocarbon in the petroleum product.

3. The apparatus of claim 1, wherein the heater is a conductive heater and heats the sample reservoir.

4. The apparatus of claim 1, wherein the heater is a radiant heater and heats the sample via radiation.

5. The apparatus of claim 1, wherein the sample reservoir and vapor collector form a sealable chamber such that vapors released by heating of the petroleum product are captured in the vapor collector for spectroscopic analysis.

6. The apparatus of claim 1, wherein the apparatus is further adapted to receive a used motor oil sample and detect fuel contamination in the sample.

7. The apparatus of claim 1, wherein the apparatus further comprises a temperature sensor.

8. The apparatus of claim 1, wherein the apparatus further comprises at least one sensor and a controller responsive to the sensor.

9. The apparatus of claim 1, wherein the apparatus further comprises a light source and an infrared detector.

10. The apparatus of claim 1, wherein the apparatus further comprises a light source and multiple infrared detectors position to analyze vapor in the vapor collection area.

11. The apparatus of claim 10, wherein the distance between the light source and a first detector is longer than between the light source and a second detector.

12. The apparatus of claim 11, wherein the first detector detects diesel fuel vapors and the second detector detects gasoline fuel vapors.

13. The apparatus of claim 10, wherein the light source is mechanically or electrically pulsed at a stable frequency in the range of about 3 Hz to 100 Hz.

14. An apparatus for spectroscopic analysis of motor oil, comprising:
a receptacle for a disposable sample reservoir;
a heater for heating a disposable sample reservoir;
a vapor collector chamber adapted for collecting vapors released by heating a liquid sample; and
an infrared spectrometer for analyzing vapors in the vapor collector.

15. The apparatus of claim 14, including at least one disposable sample reservoir.

16. The apparatus of claim 14, wherein the spectrometer further comprises an infrared light source and an infrared detector designed to detect the spectroscopic signature of hydrocarbon vapor.

17. The apparatus of claim 16, wherein the apparatus further comprises a data processor for analyzing spectroscopic data and quantifying an amount of fuel contamination present in a motor oil sample.

18. The apparatus of claim 14, wherein the receptacle for receiving the disposable sample reservoir is adapted to slide at least partially out of the vapor collection chamber.

19. The apparatus of claim 14, wherein the vapor collection chamber includes a resealable door.

20. A method for spectroscopic analysis of motor oil, comprising:
delivering a motor oil sample containing a volatile contaminant to a sampling reservoir;
heating the sample to increase the vapor-phase concentration of the volatile contaminant; and
spectroscopically analyzing the vapor-phase.

21. The method of claim 20, wherein the petroleum sample is heated a temperature sufficient to at least partially vaporize fuel contaminants present in a motor oil sample.

22. The method of claim 20, wherein the heater heats the sample to a temperature in the range of about 55° C. and 120° C.

23. The method of claim 20, wherein spectroscopically analyzing the vapor-phase data includes synchronous demodulation.

24. The method of claim 20, wherein the method further comprises comparing spectroscopic data with known values for fuel contaminants.

25. The method of claim 20, wherein the method further comprises quantifying fuel contaminants present in the motor oil sample based on the spectroscopic investigation of the vapor-phase components.

26. The method of claim 20, further comprising calibrating the device using at least one known standard sample.

27. The method of claim 26, wherein the calibrating procedure comprising spectroscopically analyzing a series of oil samples doped with known amounts of gasoline or diesel fuel.

28. The method of claim 26, wherein the standard sample comprises at least one hydrocarbon with a known vapor spectrum, and the step of calibrating the device further comprises dividing the motor oil sample into at least two portions and adding the hydrocarbon to one of the portions.

29. The method of claim 28, further comprising spectroscopically analyzing the at least two portions of the sample and using the data collected from the sample containing the hydrocarbon as a reference.
